(19) United States
(12) Patent Application Publication
(10) Pub. No.: US 2012/0294022 A1
(43) Pub. Date: Nov. 22, 2012

(54) SOCKET FOR AN AUTOMOTIVE HID LAMP WITH REDUCED HEIGHT AND METHOD OF MANUFACTURING A SOCKET

(75) Inventors: Juergen Gerhard Mertens, Aachen (DE); Lars Dabringhausen, Aachen (DE)

(73) Assignee: KONINKLIJKE PHILIPS ELECTRONICS N.V., EINDHOVEN (NL)

(21) Appl. No.: 13/574,632

(22) PCT Filed: Jan. 18, 2011
(86) PCT No.: PCT/IB2011/050214

§ 371 Date: Jul. 23, 2012

(30) Foreign Application Priority Data
Jan. 26, 2010 (EP) 10151678.9

(51) Int. Cl. B60Q 1/04; H01R 43/20

(52) U.S. Cl. 362/487; 29/876

(57) ABSTRACT

It is provided a socket (16) for an automotive lamp (10), particularly HID lamp, for use in an automotive headlight (12), comprising a bottom housing part (24) comprising a bottom surface (30) defining a proximal end of the socket (16), a top housing part (26) directly connected to the bottom housing part (24), wherein the top housing part (26) comprises a top surface (32) pointing away from the bottom housing part (24), and reference protrusions (36) for aligning a burner (14) with respect to the reference protrusions (36) during connecting the burner (14) to the socket (16), wherein the reference protrusions (36) protrudes from the level (34) of the top surface (32) or starting from below the level (34) of the top surface (32). Since a metal reference ring protruding from the socket (16) can be saved the height of the socket (16) can be reduced leading to a reduced total height of an automotive lamp (10) comprising this socket (16). The reduced total height of the automotive lamp (10) enables a reduction of the required building space of an automotive headlight (12), particularly in driving direction (50). This enables a further optimization of the required building space of the automotive headlight (12).

### FIELD OF THE INVENTION

The invention relates to the field of sockets for automotive lamps as well as a method of manufacturing such kind of socket, wherein it is possible by means of such kind of socket to support and electrically connect a burner for emitting light.

### BACKGROUND OF THE INVENTION

A HID (“high intensity discharge”) automotive lamp is known comprising a HID burner for emitting light provided with a metal clamp surrounding a part of a glass body of the HID burner. The HID burner is welded to a metal reference ring via metal lugs welded to the metal clamp. The metal reference ring comprises several fastening means for connecting the burner to a reflector housing of an automotive headlight. The metal reference ring further comprises three reference protrusions for aligning the burner with respect to the reference protrusions during welding the burner to the metal reference ring. By means of the reference protrusions the light source of the burner can be exactly positioned with respect to the reference protrusions during welding, wherein the correct alignment can be monitored by optical methods. This enables in turn an exact alignment of the light source of the burner with respect to the reflector of the headlight after assembling the HID lamp within the headlight. In a next assembling step the metal reference ring is connected to a socket made from a heat resistant plastic material after aligning the burner and after welding the burner to the metal reference ring. The socket comprises a starting circuit for starting the burner and for electrically connecting the burner to a plug for connecting an electrical source.

There is a permanent need of optimizing the required building space of automotive head-lights.

### SUMMARY OF THE INVENTION

It is an object of the invention enabling a further optimization of the required building space of an automotive headlight. It is particularly an object of the invention providing a socket for an automotive lamp, particularly an HID lamp, by means of which the total height of the automotive lamp can be reduced, preferably without impairing the correct alignment of a burner with respect to the socket or with respect to an automotive headlight.

This object is achieved by a socket for an automotive lamp, particularly HID lamp, for use in an automotive headlight, comprising a bottom housing part comprising a bottom surface defining a proximal end of the socket, a top housing part directly connected to the bottom housing part, wherein the top housing part comprises a top surface pointing away from the bottom housing part, and reference protrusions for aligning a burner with respect to the reference protrusions during connecting the burner to the socket, wherein the reference protrusions protrudes starting from the level of the top surface and/or starting from below the level of the top surface.

Since a metal reference ring protruding from the socket can be saved the height of the socket can be reduced leading to a reduced total height of an automotive lamp comprising this socket. The reduced total height of the automotive lamp enables a reduction of the required building space of an automotive headlight, particularly in driving direction. This enables a further optimization of the required building space of the automotive headlight. The reference ring can be positioned deepened in the socket within a respective recess, so that the reference protrusions may even start from below the level of the top surface. The reference protrusion may be positioned closer to the bottom surface than the top surface. Particularly the reference protrusion may be positioned in a deepened recess of an at least partially mainly U-shaped housing of the socket viewed in cross sectional side view. Preferably the functions of the former reference ring are provided by the top housing part itself. All functions of the former reference ring can be combined into the top housing part rendering a separate reference ring unnecessary. The height of the socket can be ruled only by the necessary height for receiving the burner and providing a minimum insulation of the poles of the burner. A starter circuit and further electric elements located inside the socket can be arranged preferably laterally to a burner received by the socket. If so, the design of the socket can be chosen such that in assembled state parts of the socket encompass a part of the housing of the automotive headlight. The electric components of the socket can be positioned at a place where unused space is present. The required building space of the headlight, particularly in driving direction, can be significantly reduced.

It is understood that the bottom surface of the bottom housing part, be means of which a proximal end of the socket is defined, can be placed onto a ground without a further part of the lamp between the bottom housing part and the ground, wherein a burner received by the socket may point mainly in opposite direction of gravity direction. Further the top housing part is directly connected to the bottom housing part. A reference ring which is only indirectly connected to the bottom housing part is understood as not being the top housing part and understood as not being part of the socket. It is understood that the top surface of the top housing part is the largest area of the top housing part pointing in opposite direction away from the bottom surface. Between the top housing part and the bottom housing part a plastic heat resistant insulation material, particularly PPS (polyphenylene sulfide, (SC₆H₄)ₙ) may be provided for insulating the poles of a received burner. Since the reference protrusions protrudes from the level of the top surface and/or from below the level of the top surface mainly the whole space between the top surface and the bottom surface can be used for arranging electronic components and for providing a sufficient insulation of the poles of a received burner. At the same time no unnecessary protrusions from the socket which may lead to an unnecessarily increased height are provided. The minimal height of the socket is determined by the distance of the bottom surface to the top surface. The height of the socket is determined by the distance of the bottom surface to the most distant tip of a protrusion protruding away from the top surface. The total height of the respective automotive lamp is the distance of the bottom surface to the distal tip of a burner received by the socket. A HID lamp is a high density discharge lamp comprising a burner with a discharge vessel which is particularly adapted for operating at a pressure up to 1 MPa, wherein the discharge vessel may be filled with a noble gas like xenon, krypton and/or neon and may comprise a halogen and/or metal halide and/or mercury. The reference protrusions, particularly three reference protrusions, are provided for aligning the burner with respect to the reference protrusions during connecting the burner to the socket. By means of the reference protrusions the light source of the burner can be exactly positioned with respect to the reference protrusions during the connecting, wherein the correct alignment can be monitored by optical methods. This enables in turn an exact alignment of the light source of the burner with respect to a reflector of an automotive headlight after assembling the automotive lamp within the headlight.

Particularly the reference protrusions are one-piece with the top housing part. The burner may be connected directly to the top housing part and/or received directly by the top housing part without an additional intermediate part. The number of assembling parts can be reduced. Particularly the housing of the socket may consist of only the top housing part and the bottom housing part. Further the manufacturing of the socket can be simplified. The reference protrusions may be provided during the manufacturing of the top housing part particularly by stamping and/or other particularly non-machining forming techniques.

Preferably the bottom housing part as well as the top housing part are made from a metal material, particularly mainly comprising alumina. Due to the metal material the top housing part may be connected to a burner by welding, particularly laser welding. Further the reference protrusions may be provided by the top housing part itself, particularly by stamping. Further the top housing part and the bottom housing part may be connected to each other by clamping and/or welding particularly laser welding. Particularly the metal housing may increase the cooling of the lamp during operation and may at least reduce an outgassing of material positioned inside the metal housing. It is prevented that outgassed material from inside the socket, particularly from plastic components, may condense at a glass body of the burner. This improves the optical performance of the lamp over the life-time of the lamp.

Particularly preferred the top surface is only provided by the top housing part and the top surface is mainly stepless flat besides the reference protrusions, besides a particularly provided collar bordering an insertion opening for inserting the burner and besides particularly provided connection lugs for connecting the burner to the socket. Since only the top housing part may provide the top surface no reference ring arranged in the plane of the top housing part is necessary. The top surface provided by the top housing part covers particularly at least 80%, preferably at least 85%, particularly preferred at least 90% and most preferred 95% of the area of the bottom surface. Besides the elements for providing the functions of a reference ring the top surface may be provided by a flat plate-like part of the top housing without additional steps within the area of the top surface. The top housing part may comprise one or more openings, wherein the openings are not understood as providing a step.

Particularly a distance d between the level of the top surface and the bottom surface is d≦30 mm, particularly d≦25 mm, preferably d≦20 mm and particularly preferred d≦17 mm. Such distance is small enough for providing a reduction of the height of the socket, wherein at the same time enough space is provided for securely receiving the burner by the socket and for providing an insulation of the poles of the burner. Further enough space may be provided between the top housing part and the bottom housing part for arranging electrical components like a starter circuit for starting the burner. Preferably the distance d between the top surface and the bottom surface is d≧5 mm, particularly d≧10 mm and most preferred d≧15 mm.

Preferably the top housing part comprises at least one fastener, particularly a fastening opening for receiving a fastening hook, for connecting the socket to an automotive headlight. The fastener may be provided by the top housing part itself without an additional intermediate part. The at least one fastener may provide a self-centering effect when connected to a headlight, particularly to a reflector housing of the headlight. Since the position of the fastener as well as the position of the reference protrusions may be fixed with respect to the top housing part the position of the light source of the burner may be correctly positioned within the headlight with an increased accuracy. A reduced accuracy due to the connection of several parts manufactured with a certain tolerance is prevented. The socket of the lamp may be directly connected to the headlight via the fastener of the top housing part. The at least one fastener may be provided as opening for receiving a hook or the like. Hence, the fastener of the top housing part may be provided by stamping particularly at the same time when providing the shape of the top housing part and/or the reference protrusions.

In a preferred embodiment the top housing part comprises at least one connection lug for connecting the burner to the socket, wherein the at least one connection lug is one-piece with the top housing part and particularly producible by stamping the top housing part. The connection lug may be formed out from the plane of the top surface particularly protruding at least partially from the bottom surface away. The at least one connection lug, particularly at least three or four connection lugs may clamp the burner and/or may be weld on the burner, for instance via a metal ring clamped to the burner.

In a further embodiment the top housing part comprises an insertion opening for inserting the burner into the socket, wherein the insertion opening is displaced with respect to the centre of area of the top surface. Due to the displacement the connection of the burner may be provided at a first region of the socket and the electronic components located inside the socket may be provided at a second region spaced to the first region. An increased insulating gab may be provided between the poles of the burner and the electronic components without the need of providing an increased height of the socket.

The invention further relates to an automotive lamp for a headlight comprising a burner, particularly a HID burner, connected to a socket which may be designed as previously described. Since a metal reference ring protruding from the socket can be saved the height of the socket can be reduced leading to a reduced total height of the automotive lamp. The reduced total height of the automotive lamp enables a reduction of the required building space of an automotive headlight, particularly in driving direction. This enables a further optimization of the required building space of the automotive headlight.

The invention further relates to a headlight for an automotive comprising a reflector housing connected to an automotive lamp via the top housing part of the socket, wherein the automotive lamp and/or the socket may be designed as previously described. Since a metal reference ring protruding from the socket can be saved the height of the socket can be reduced leading to a reduced total height of the automotive lamp comprising this socket. The reduced total height of the automotive lamp enables a reduction of the required building space of the automotive headlight, particularly in driving direction. This enables a further optimization of the required building space of the automotive headlight.

The invention further relates to a method for manufacturing a socket for an automotive lamp, particularly HID lamp, for use in an automotive headlight, comprising the steps of providing a bottom housing part comprising a bottom surface defining a proximal end of the socket, providing a top housing part comprising a top surface pointing away from the bottom housing part, providing reference protrusions for aligning the burner with respect to the reference protrusions during connecting the burner to the socket such that the reference protrusions protrudes starting from the level of the top surface and/or starting from below the level of the top surface, and directly connecting the top housing part to the bottom housing part. Since a metal reference ring protruding from the socket can be saved the height of the socket can be reduced leading to a reduced total height of an automotive lamp comprising this socket. The reduced total height of the automotive lamp enables a reduction of the required building space of an automotive headlight, particularly in driving direction. The method can be further designed as previously described with reference the socket and/or the automotive lamp and/or the headlight. Particularly a socket designed as previously described and/or an automotive lamp designed as previously described and/or a headlight designed as previously described is obtained.

Particularly the reference protrusions are provided by stamping the top housing part. The reference protrusions may be provided by the top housing part itself without the need of an additional intermediate part. The assembly and the manufacturing of the socket may be facilitated.

Preferably a burner is aligned with respect to the reference protrusions and subsequently directly connected to the top housing part, particularly by laser welding. The burner may be in correctly aligned state directly connected to the socket via the top housing part. A further assembly step of connecting an additional intermediate part to the socket is saved. The assembly of the lamp may be facilitated and accelerated.

Particularly preferred a reflector housing of an automotive headlight is directly connected to the top housing part. The reflector housing is particularly detachably connected to the top housing part for facilitating the exchange of the burner. It is not necessary to connect the reflector housing via an additional intermediate part to the socket.

Particularly a socket designed as previously described and/or an automotive lamp designed as previously described and/or a headlight designed as previously described is obtained.

### BRIEF DESCRIPTION OF THE DRAWINGS

These and other aspects of the invention will be apparent from and elucidated with reference to the embodiments described hereinafter.

In the drawings:

FIG. 1 is a schematic perspective view of an automotive lamp in a first embodiment of the invention,

FIG. 2 is a schematic side view of the lamp illustrated in FIG. 1,

FIG. 3 is a schematic cross sectional view of an automotive headlight comprising the lamp illustrated in FIG. 1, and

FIG. 4 is a schematic perspective view of an automotive lamp in a second embodiment of the invention.

### DETAILED DESCRIPTION OF EMBODIMENTS

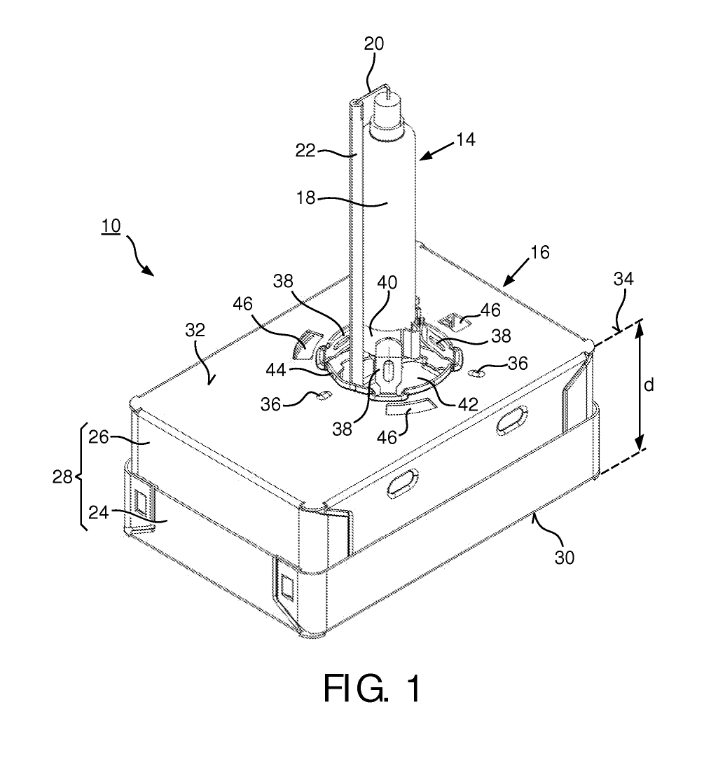

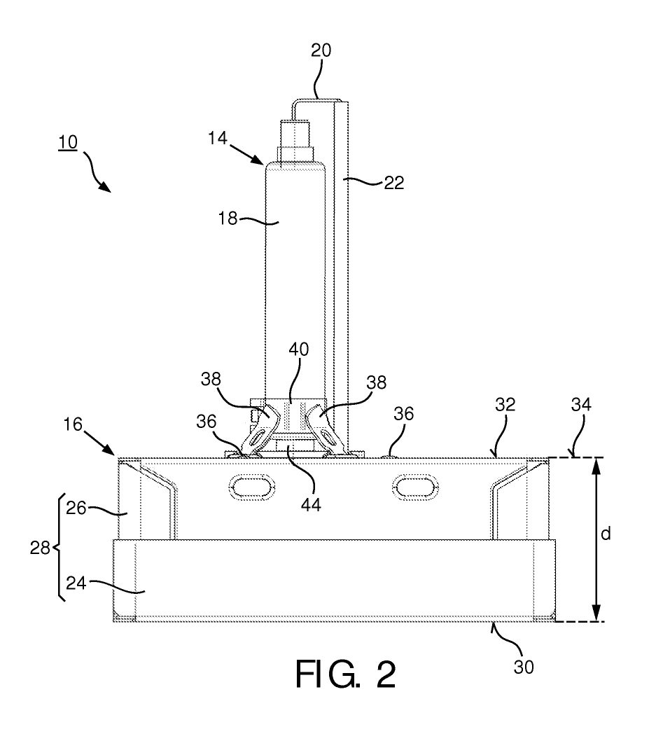

The lamp 10 illustrated in FIG. 1 and FIG. 2 is adapted for being inserted into an automotive headlight 12. The lamp 10 comprises a burner 14 which is received by a socket 16. The burner comprises a glass body 18, into which a not illustrated discharge vessel 19 is positioned. Two electrodes 20 terminate inside the discharge vessel 19 for providing a discharge arc. One of the electrodes 20 is led into the socket 16 via an insulated backlead wire 22.

The socket 16 comprises a metal bottom housing part 24 directly connected to a metal top housing part 26. The bottom housing part 24 and the top housing part 26 form together a housing 28 of the socket 16. The bottom housing part 24 comprises at the proximal end of the socket 16 a bottom surface 30 pointing in opposite direction of a top surface 32 of the top housing part 26. The top surface 32 defines a level 34 of the top surface 32. A distance d is provided between the bottom surface 30 and the level 34 or the top surface 32, respectively.

In the illustrated embodiment three reference protrusions 36 are provided by the top housing part 26. Each reference protrusion 36 starts from the level 34 of the top surface 32. At the same time each reference protrusion 36 protrudes in a direction away from the bottom surface 30. The reference protrusions 36 are used during the assembling of the lamp 10 for aligning the burner 14 with respect to the reference protrusions 36 during connecting, particularly laser welding, the burner 14 to the metal top housing part 26. By means of the reference protrusions 36 the light source of the burner 14 can be exactly positioned with respect to the reference protrusions 36, wherein the correct alignment can be monitored by optical methods.

In the illustrated embodiment the top housing part 26 comprises several lugs 38. The lugs 38 are one-piece with the metal top housing part 26 and manufactured by stamping the top housing part 26 and bending the lugs 38 out of the area of the top surface 32. The lugs 38 can be welded to a clamping ring 40 which immovably surrounds the glass body 18 of the burner 14. The lugs 38 protrude from a rim of an insertion opening 42 for inserting the burner 14 into the socket 16. The insertion opening is bordered by a collar 44 which protrudes from the top surface 32 of the top housing part 26 in a direction away from the bottom surface 30. The top housing part 26 is further provided with several fasteners 46 in the form of openings each for receiving a fastening hook of a reflector housing 48 of an automotive headlight 12.

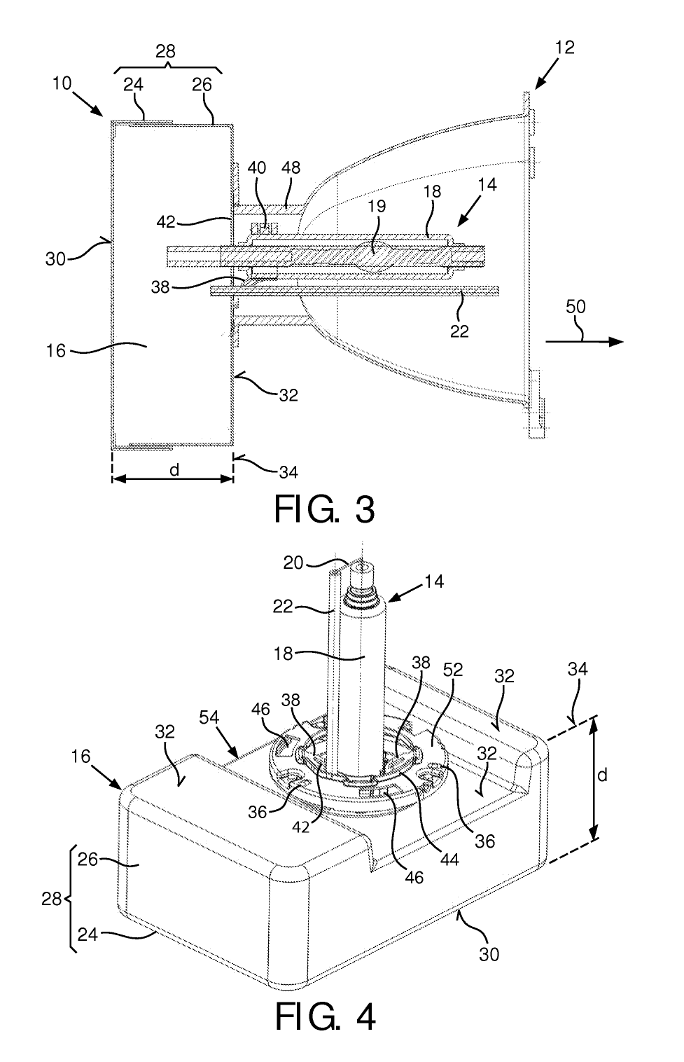

As illustrated in FIG. 3 the required building space of the headlight 12 of an automotive can be reduced. Due to the reduced distance d the height of the lamp 10 is reduced. Particularly the height of the socket 16 is reduced so that the required building space for the part of the lamp 10 protruding from the reflector housing 48 is reduced. This leads to a reduced building space particularly in driving direction 50 of the automotive. The reflector housing 48 is directly connected to the top housing part 26 without an additional intermediate part.

In a further embodiment of the lamp 10 a reference ring 52 is not saved but positioned deepened in the socket 16 as illustrated in FIG. 4. The socket 16 is formed mainly U-shaped in side view for providing a recess 54 for receiving the reference ring 52. The reference protrusions 36 may even start below the level 34 of the main part of the top surface 32. Electric components of the lamp 10 can be placed besides the burner 14 inside the socket 16.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the deepened recess 54 is provided without a reference ring 52, wherein the reference protrusions 36 are provided by the top housing part 26 itself. Further it is possible that one reference protrusion 36 starts from the level 34 of the top surface 32 and a further reference protrusion 36 starts from below the level 34 of the top surface 32. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. Socket for an automotive lamp (10), particularly for an HID lamp, for use in an automotive headlight (12), comprising:
a bottom housing part (24) comprising a bottom surface (30) defining a proximal end of the socket (16),
a top housing part (26) directly connected to the bottom housing part (24),
wherein the top housing part (26) comprises a top surface (32) pointing away from the bottom housing part (24), and
reference protrusions (36) for aligning a burner (14) with respect to the reference protrusions (36) during connecting the burner (14) to the socket (16),
wherein the reference protrusions (36) protrude starting from the level (34) of the top surface (32) and/or starting from below the level (34) of the top surface (32).

2. Socket according to claim 1 wherein the reference protrusions (36) are one-piece with the top housing part (26).

3. Socket according to claim 2 wherein the top surface (32) is only provided by the top housing part (26) and the top surface (32) is mainly stepless flat besides the reference protrusions (36), besides a particularly provided collar (44) bordering an insertion opening (42) for inserting the burner (14) and besides particularly provided connection lugs (38) for connecting the burner (10) to the socket (16).

4. Socket according to claim 1 wherein a distance d between the level (34) of the top surface (32) and the bottom surface (30) is d≦30 mm, particularly d≦25 mm, preferably d≦20 mm and particularly preferred d≦17 mm.

5. Socket according to claim 1 wherein the top housing part (26) comprises at least one fastener (46), particularly a fastening opening for receiving a fastening hook, for connecting the socket (16) to an automotive headlight (12).

6. Socket according to claim 1 wherein the top housing part (26) comprises at least one connection lug (38) for connecting the burner (14) to the socket (16), wherein the at least one connection lug (38) is one-piece with the top housing part (26) and particularly producible by stamping the top housing part (26).

7. Socket according to claim 1 wherein the top housing part (26) comprises an insertion opening (42) for inserting the burner (14) into the socket (16), wherein the insertion opening (42) is displaced with respect to the centre of area of the top surface (32).

8. Socket according to claim 1 wherein the bottom housing part (24) as well as the top housing part (26) are made from a metal material, particularly mainly comprising alumina.

9. Automotive lamp for a headlight (12) comprising a burner (14), particularly a HID burner, connected to a socket (16) according to claim 1.

10. Headlight for an automotive comprising a reflector housing (48) connected to an automotive lamp (10) according to claim 9 via the top housing part (26) of the socket (16).

11. Method for manufacturing a socket (16) for an automotive lamp (10); particularly HID lamp, for use in an automotive headlight (12), comprising the steps of:
providing a bottom housing part (24) comprising a bottom surface (30) defining a proximal end of the socket (16),
providing a top housing part (26) comprising a top surface (32) pointing away from the bottom housing part (24),
providing reference protrusions (36) for aligning the burner (14) with respect to the reference protrusions (36) during connecting the burner (14) to the socket (16) such that the reference protrusions (36) protrude starting from the level (34) of the top surface (32) and/or starting from below the level (34) of the top surface (32), and
directly connecting the top housing part (26) to the bottom housing part (24).

12. Method according to claim 11 wherein the reference protrusions (36) are provided by stamping the top housing part (26).

13. Method according to claim 11 wherein a burner (14) is aligned with respect to the reference protrusions (36) and subsequently directly connected to the top housing part (26), particularly by laser welding.

14. Method according to claim 11 wherein a reflector housing (48) of an automotive headlight (12) is directly connected to the top housing part (26).

15. Method according to claim 11 wherein a socket and/or an automotive lamp and/or a headlight is obtained.
